(19) United States
(12) Patent Application Publication
(10) Pub. No.: US 2009/0150565 A1
(43) Pub. Date: Jun. 11, 2009

(54) SOA infrastructure for application sensitive routing of web services

(75) Inventors: Clifford Grossner, Ottawa (CA); Laura Serghi, Ottawa (CA); Piragash Velummylum, Seattle, WA (US)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/987,813

(22) Filed: Dec. 5, 2007

(51) Int. Cl. G06F 15/16

(52) U.S. Cl. 709/241

(57) ABSTRACT

Various exemplary embodiments are a system and related method for application sensitive forwarding of a request for a web service including a broker that manages the forwarding of the request, a metric table that stores statistics for the web service, and a database storing the metric table and least one load balancing policy. Various exemplary embodiments include an optimization policy manager that manages forwarding of the request, a class of services table that stores information, and a database storing the class of services table and at least one optimization policy. Various exemplary embodiments include a database storing a security-based policy and a location-based policy defining trust environments, a request processor that receives the request from the client and determines a current environment of the client based on the at least one location-based policy, and a quarantining subsystem that drops the request when the request violates the security-based policy.

### BACKGROUND OF THE INVENTION

1. Field of the Invention

This invention relates generally to the use of web services.

2. Description of Related Art

Modern enterprises routinely rely on a multitude of applications operating on a variety of platforms and operating systems. In the past, enterprises were often required to develop customized solutions to allow their applications to interact with one another. Consequently, the process of enabling applications to exchange information was costly and time-consuming.

The web services platform solves these problems by providing a standard means of interoperating between software applications running on different platforms and frameworks. By standardizing communication protocols, representation formats, description languages, and discovery mechanisms, the web services platform provides true interoperability between applications.

Service Oriented Architecture (SOA) is a design philosophy that directs how Information Technology (IT) resources will be integrated and which web services will be exposed for use. The IT infrastructure of a typical corporation includes data, legacy systems, line-of-business applications, packaged applications, and trading partners. SOA infrastructures enable a corporation to tie together these sources of information, thereby bridging a wide range of operating systems, technologies, and communication protocols. Thus, implementation of an SOA infrastructure allows the creation of new web services, aggregation of these web services into larger composite applications, and consumption of these applications by end-users.

While SOA infrastructures increase the availability of applications and data, they are accompanied by additional burdens. For example, the increase in the number of applications causes a corresponding increase in server workload and infrastructure complexity. Thus, there is a need for efficient and inexpensive systems and methods of exchanging information between applications.

The foregoing objects and advantages of the invention are illustrative of those that can be achieved by the various exemplary embodiments and are not intended to be exhaustive or limiting of the possible advantages which can be realized. Thus, these and other objects and advantages of the various exemplary embodiments will be apparent from the description herein or can be learned from practicing the various exemplary embodiments, both as embodied herein or as modified in view of any variation which may be apparent to those skilled in the art. Accordingly, the present invention resides in the novel methods, arrangements, combinations and improvements herein shown and described in various exemplary embodiments.

### SUMMARY OF THE INVENTION

Currently, there are no available solutions that allow an enterprise to set application-level policy across many web service transactions in a stateful manner to control access to web services, balance load on application servers, optimize costs when consuming external web services, and secure external access to internal web services.

Accordingly, there is a need for a Service Oriented Architecture (SOA) infrastructure that allows web services distribution to occur in a dynamic manner in the network at the Web Services Gateway (WSG) or Web Services Intranet Platform WSIP (WSIP), rather than at the endpoint or application server. There is also a need for policy-driven web services distribution that allows load balancing based on a multitude of application level metrics.

In light of the present need for an SOA infrastructure for application sensitive routing of web services, a brief summary of various exemplary embodiments is presented. Some simplifications and omission may be made in the following summary, which is intended to highlight and introduce some aspects of the various exemplary embodiments, but not to limit its scope. Detailed descriptions of a preferred exemplary embodiment adequate to allow those of ordinary skill in the art to make and use the invention concepts will follow in later sections.

Various exemplary embodiments for load balancing rely on IP routing, examination of XML packets of individual web service transactions, and execution of load balancing tools that are used to distribute web service applications between servers. Such embodiments, however, often cannot apply across a stateful session and therefore limit the ability to load balance based on application level parameters. In addition, these embodiments sometimes require manual specification of load balancing parameters at the server that is hosting the web service.

Accordingly, various exemplary embodiments allow an enterprise to use policies to dynamically manage access to web services, thereby balancing load on application servers, reducing costs when consuming external web services, and securing external access to internal web services. Thus, various exemplary embodiments provide application level control at a web services gateway that enables an enterprise to provide efficient operations, reduce costs, and obtain additional security from external threats.

In various exemplary embodiments, these objectives are accomplished by performing load-balancing at the web services gateway using a plurality of application level metrics, such as peak hour distribution of application requests, geographic time frame, request location, and average response time for a specific time period. Accordingly, various exemplary embodiments assure delivery of a web service to the client without the need for specifying load balancing parameters at the client server.

In various exemplary embodiments, a web services product suite allows enterprises to provide proper corporate governance and to provide a managed partner extranet that allows for secure integration of internal applications with business processes at external partner corporations. Proper corporate governance requirements include the ability to demonstrate and enforce regulation compliance, the ability to provide consolidated dashboards and audit trails, and the ability to integrate IT systems directly with corporate business processes.

In various exemplary embodiments, the web services product suite includes at least one of a Web Services Gateway (WSG), a Web Services Intranet Platform (WSIP), and a Web Services Manager (WSM). The WSG is a network node positioned in a corporation's demilitarized zone, which is the area located between a company's private network and the outside public network. Sometimes the demilitarized zone is inside a firewall, while other times it is outside a firewall. In various exemplary embodiments, the WSG processes web service messages in real time in order to facilitate integration with web services at various partner corporations.

In various exemplary embodiments, the WSIP is a network node positioned in the data center that processes web services messages in real time. In various exemplary embodiments, the WSM is a network and service management element deployed by an enterprise to coordinate web service message processing nodes and maintain a central service registry of all web services published by the enterprise and policies associated with those services.

In various exemplary embodiments, the WSG, WSIP, and WSM allow a corporation to set a policy that can be enforced at runtime to allow the corporation to optimize the load on internal application servers. Accordingly, in various exemplary embodiments, the policy dynamically adjusts as the load on each application server increases, automatically adjusts consumption of external web services to minimize costs, and secures service transaction access depending upon the individual requesting access and the trust level established at the individual's current external location. Furthermore, in various exemplary embodiments, the policy reroutes the web service request to a different service for additional virus protection and to adjust the class of service to be made available.

### BRIEF DESCRIPTION OF THE DRAWINGS

In order to better understand various exemplary embodiments, reference is made to the accompanying drawings, wherein:

FIG. 1 is a schematic diagram of an exemplary embodiment of a system for application sensitive forwarding based on an application layer load balancing model;

FIG. 2 is a diagram illustrating an exemplary embodiment of a forwarding table used in connection with a system for application sensitive forwarding;

FIG. 3 is a diagram illustrating an exemplary embodiment of a metric table used in connection with a system for application sensitive forwarding;

FIG. 4 is a schematic diagram of an exemplary embodiment of a system for application sensitive forwarding based on optimization policies;

FIG. 5 is a diagram illustrating an exemplary embodiment of a class of services table used in connection with a system for application sensitive forwarding;

FIG. 6 is a schematic diagram of an exemplary embodiment of a system for restricting access to web services using a location-based and security-based policy;

FIG. 7 is a diagram illustrating an exemplary embodiment of a location-based policy forwarding table used in connection with a system for restricting access to web services;

FIG. 8 is a flow chart of an exemplary embodiment of a method for application sensitive forwarding based on an application layer load balancing model; and

FIG. 9 is a flow chart of an exemplary embodiment of a method for application sensitive forwarding based on optimization policies.

### DETAILED DESCRIPTION OF THE PREFERRED EMBODIMENTS OF THE INVENTION

Referring now to the drawings, in which like numerals refer to like components or steps, there are disclosed broad aspects of various exemplary embodiments.

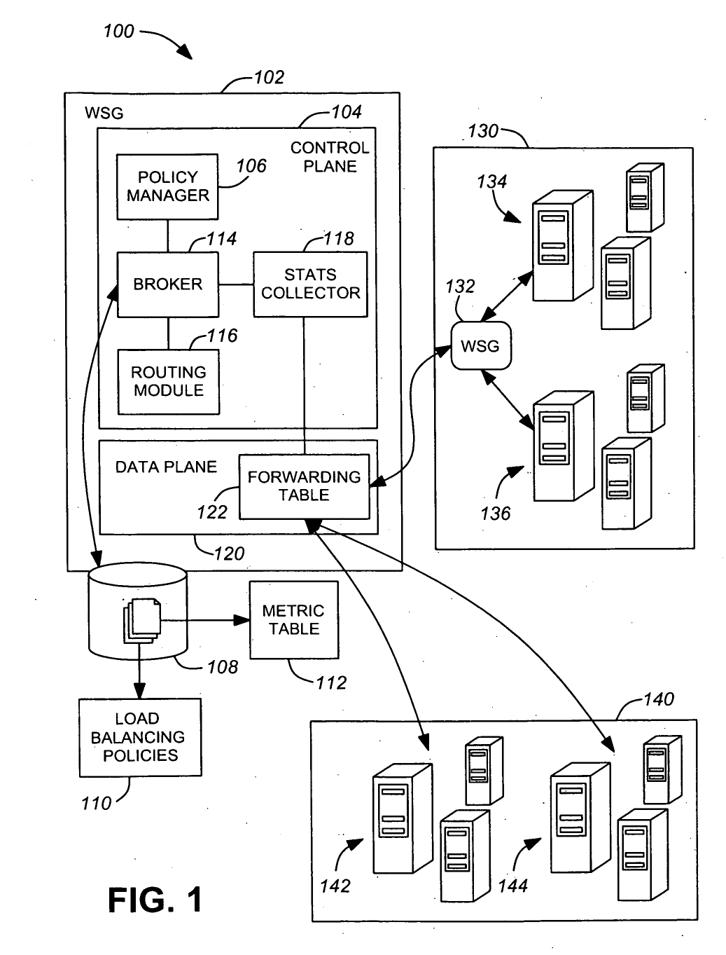

FIG. 1 is a schematic diagram of an exemplary embodiment of a system 100 for application sensitive forwarding based on an application layer load balancing model. Exemplary system 100 provides enterprises the ability to set run-time application level policies to dynamically control routing to web services for the purpose of application load balancing. Accordingly, in various exemplary embodiments, exemplary system 100 dynamically manages forwarding of web service requests using statistics collected at runtime such as, for example, response times for web services requests, current peak hour loads, and geographic distribution of requests.

Exemplary system 100 includes a web services gateway (WSG) 102, which includes a control plane 104 and a data plane 120. In various exemplary embodiments, control plane 104 includes policy manager 106, broker 114, routing module 116, and statistics or stats collector 118. Exemplary system 100 further includes extended registry 108, which stores load balancing policies 110 and metric table 112. In various exemplary embodiments, data plane 120 includes a forwarding table 122.

Exemplary system 100 includes two offices, first office 130 and second office 140, which offer at least two web services in common. It should be apparent that other exemplary embodiments have a number of offices other than two and that, in various exemplary embodiments, each office has a number of web service hosts other than two. As depicted, first office 130 includes first office web services gateway 132, web service A host 134, and web service B host 136, while second office 140 includes web service A host 142 and web service B host 144.

WSG 102 of exemplary system 100 is a middleware component that provides an intermediary framework between Internet and intranet environments during Web service invocations. In various exemplary embodiments, WSG 102 receives incoming web services requests in Simple Object Access Protocol (“SOAP”) or Extensible Markup Language (“XML”) format and must determine where to forward the request. By utilizing the various components discussed in detail herein, WSG 102 of exemplary system 100 receives and forwards requests based on an application layer load balancing model, thereby facilitating integration with web services at various partner corporations. It should be apparent that, in various exemplary embodiments, WSG 102 is replaced with a WSIP, WSM, or another component suitable for receiving and forwarding web service requests.

Control plane 104 of exemplary system 100 includes a policy manager 106, which manages all regular web services policies. In various exemplary embodiments, web services policies set forth the capabilities, requirements, and general characteristics of the web services supported by WSG 102. In various exemplary embodiments, each web service policy includes load balancing information at the service level. Moreover, in various exemplary embodiments, a service administrator creates load balancing policies 110 for each user based on the predetermined service level agreement.

Extended registry 108 of exemplary system 100 stores the web services, web service policies, and load balancing policies 110. Thus, in various exemplary embodiments, extended registry 108 stores two types of policies: policies for web services and load balancing policies 110 for web services. In addition, in various exemplary embodiments, extended registry 108 maintains logical links between the user client applications, corresponding web services, and load balancing policies 110.

In various exemplary embodiments, extended registry 108 stores a metric table 112 containing information gathered by stats collector 118, including calculated throughput and communication delays associated with the web services supported by WSG 102. Moreover, in various exemplary embodiments, metric table 112 stores data regarding load balancing criteria including one or more of peak hour distribution of web service requests, geographic time frames, application request locations, and average service response time. Thus, through updates of the data stored in metric table 112 by stats collector 118, WSG 102 maintains real-time information regarding the specified load balancing criteria for each supported web service.

Control plane 104 of exemplary system 100 also includes a broker 114. In various exemplary embodiments, broker 114 accesses extended registry 108 to download load balancing policies 110 and metric table 112 from data plane 120 to control plane 104.

Upon receiving a request, in various exemplary embodiments, WSG 102 invokes broker 114, which runs an algorithm to choose the web service and the appropriate host for that web service. In various exemplary embodiments, broker 114 accesses the data stored in metric table 112 to determine current load information regarding the requested web service, then retrieves the corresponding load balancing policies 110 for the requested web service. Then, in various exemplary embodiments, broker 114 determines the appropriate web service based on the retrieved load information and balancing policy. Thus, in various exemplary embodiments, broker 114 applies the current load information to the retrieved balancing policy to determine which location should receive the forwarded web service request.

Control plane 104 of exemplary system 100 includes a routing module, which, in various exemplary embodiments, forwards the web service request from broker 114 to forwarding table 122, which contains user type information, destination web services, and port numbers. In various exemplary embodiments, forwarding table 122 looks up the appropriate host destination based upon the results of the processing performed at broker 114. Thus, given the appropriate web service and user type, forwarding table 122 determines the web service URL and port number, and then forwards the request to that destination for execution.

Exemplary system 100 includes two offices of Company A, first office 130 and second office 140. In various exemplary embodiments, first office 130 includes first office WSG 132. It should be apparent that, in various exemplary embodiments, first office WSG 132 processes web service messages in real time in order to facilitate integration with web services, including integration with WSG 102. In addition, in various exemplary embodiments, first office 130 supports multiple hosts of web services, including web service A host 134, which supports a first web service A, and web service B host 136, which supports a second web service B. Thus, in various exemplary embodiments, WSG 132 receives a forwarded request from WSG 102, processes the request, and forwards the request to the appropriate host for execution.

In various exemplary embodiments, second office 140 does not include a web services gateway and instead includes two hosts that communicate directly with WSG 102. Thus, in various exemplary embodiments, second office 140 includes web service A host 142, which supports a first web service A, and web service B host 144, which supports a second web service B.

It should be apparent that, while exemplary system 100 includes a separate host for each web service, a single host may support multiple web services. Thus, in various exemplary embodiments, web service A host 134, web service B host 136, web service A host 142, and/or web service B host 144 support multiple web services. Moreover, it should be apparent that although FIG. 1 depicts first office 130 and second office 140 of a Company A, in various exemplary embodiments, the offices are instead associated with vendors, affiliate companies, or partner companies.

Accordingly, in various exemplary embodiments, exemplary system 100 dynamically manages forwarding of web service requests based on an application layer load balancing model. For example, a traffic bottleneck might result due to a large number of requests during a particular time frame. In various exemplary embodiments, exemplary system 100 splits and re-directs traffic to multiple company A offices, thereby dynamically addressing the increase in web service requests.

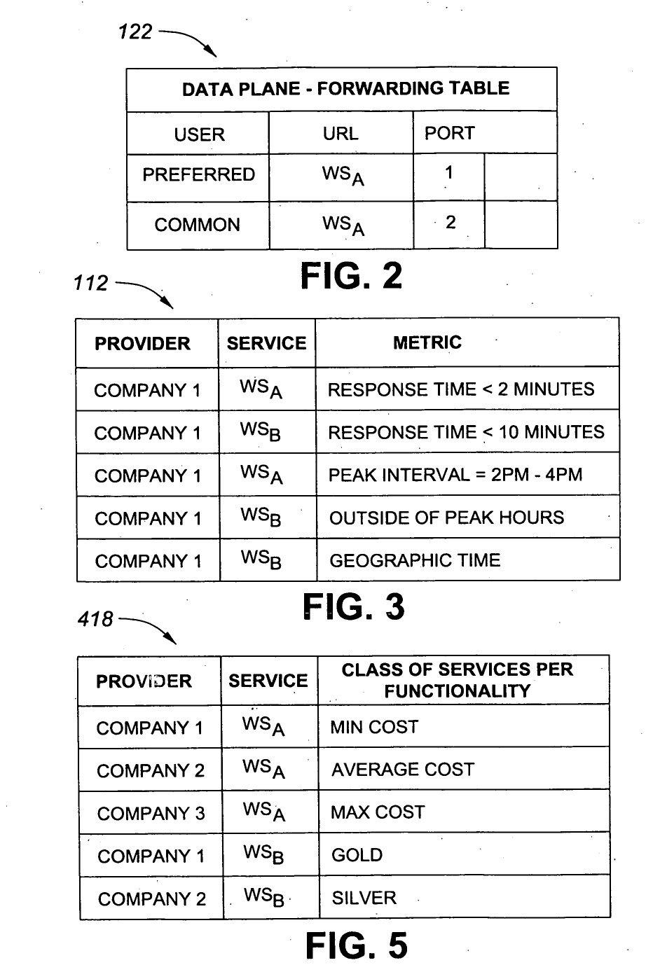

FIG. 2 is a diagram illustrating an exemplary embodiment of a forwarding table 122 used in connection with an exemplary system for application sensitive forwarding. In various exemplary embodiments, forwarding table 122 stores information regarding the user type (first column), web service URL (second column), and port number (third “dual” column) for each supported web service. Thus, in the exemplary embodiment of forwarding table 122 illustrated in FIG. 2, a preferred user is forwarded to the web service located at the URL WS_{A}, port 1 (first row of data), while a common user is forwarded to the web service located at WS_{A}, port 2 (second row of data).

FIG. 3 is a diagram illustrating an exemplary embodiment of a metric table 112 used in connection with an exemplary system for application sensitive forwarding. In various exemplary embodiments, metric table 112 stores detailed information for each of the load balancing criteria. Thus, in various exemplary embodiments, metric table 112 stores information gathered by stats collector 118 regarding each service (first column), the provider of the service (second column), and one or more metrics for each service (third column).

In the exemplary embodiment of metric table 112 illustrated in FIG. 3, Company 1 provides web service A with a response time of less than two minutes (first row of data) with its peak traffic interval between 2 p.m. and 4 p.m (third row of data). In the illustrated embodiment of metric table 112, Company 1 also provides web service B with a response time of less than 10 minutes (second row of data). As indicated in the exemplary table, Company 1 is outside of peak hours (fourth row of data) for web service B at the current time indicated by the geographic time field (fifth row of data).

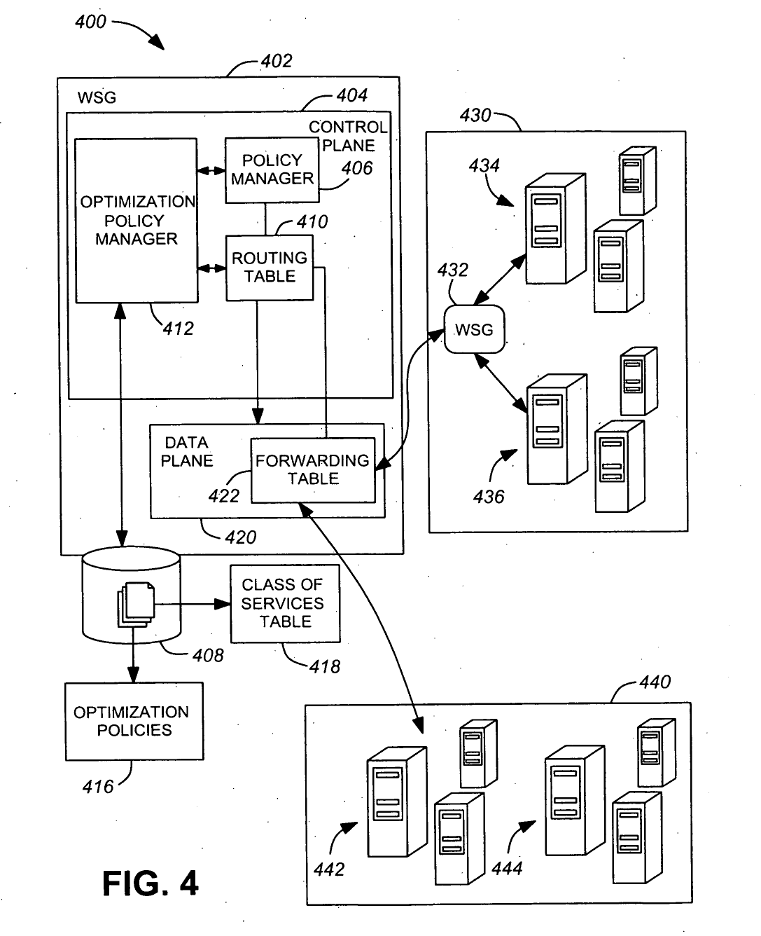

FIG. 4 is a schematic diagram of an exemplary embodiment of a system 400 for application sensitive forwarding based on optimization policies. Exemplary system 400 provides enterprises the ability to control, by means of application level policy, the selection of external web services consumed by internal employees. Accordingly, in various exemplary embodiments, exemplary system 400 optimizes access-based selection of external web services based on optimization policies. In various exemplary embodiments, these optimization policies are built based on criteria such as the cost to the enterprise for use of the service and the quality of service. Based on these optimization policies, incoming requests from internal employees are routed to the appropriate external web service.

Exemplary system 400 includes a web services gateway (WSG) 402, which includes a control plane 404 and a data plane 420. In various exemplary embodiments, control plane 404 includes policy manager 406, routing table 410, and optimization policy manager 412. Exemplary system 400 further includes extended registry 408, which stores optimization policies 416 and class of services table 418. In various exemplary embodiments, data plane 420 includes a forwarding table 422. It should be apparent that, in various exemplary embodiments, policy manager 406 is similar in functionality to policy manager 106 of exemplary system 100, while forwarding table 422 is similar in functionality to forwarding table 122.

Exemplary system 400 includes two companies, first company 430 and second company 440, which offer at least two web services in common. Thus, in various exemplary embodiments, first company 430 includes first company web services gateway 432, web service A host 434, and web service B host 436, while second company 440 includes web service A host 442 and web service B host 444.

WSG 402 of exemplary system 400 is a middleware component that provides an intermediary framework between Internet and intranet environments during Web service invocations. In various exemplary embodiments, WSG 402 receives incoming web services requests in SOAP or XML format and must determine where to forward the request. It should be apparent that, in various exemplary embodiments, WSG 402 is replaced with a WSIP, WSM, or another component suitable for receiving and forwarding web service requests.

Control plane 404 of exemplary system 400 includes a policy manager 406, which manages all regular web services policies. In various exemplary embodiments, web services policies set forth the capabilities, requirements, and general characteristics of the web services supported by WSG 402. In various exemplary embodiments, each web service policy includes class of service information related to one or optimization criterion, the class of service information comparing services from various providers and ranking them in accordance with specific measurements over a period of time. Thus, in various exemplary embodiments, the class of service is defined based on optimization criteria including at least one of the cost of the service to the corporation and the service level of the web service (e.g. gold, silver, etc.).

Optimization policy manager 412 of exemplary system 400 manages all optimization policies introduced at the WSG 402 by a service administrator. In various exemplary embodiments, these optimization policies are predetermined by a service administrator based on the service level agreement and maintain a relationship between the client user and the class of service associated with a particular web service.

Extended registry 408 of exemplary system 400 stores the web services, web service policies, and optimization policies 416. Thus, in various exemplary embodiments, extended registry 408 stores two types of policies: policies for web services and optimization policies 416. In various exemplary embodiments, extended registry 408 stores a class of services table 418, which stores information regarding one or more optimization criteria. Thus, in various exemplary embodiments, the class of services table stores information regarding the class of service for each web service supported by WSG 402. In addition, in various exemplary embodiments, extended registry 408 stores logical relations between client users, service providers, and the corresponding optimization policies.

Control plane 404 of exemplary system 400 also includes a routing table 410. In various exemplary embodiments, control plane 404 runs a routing algorithm that creates optimum routes to be fed into the routing table 410. In order to create routing table 410, in various exemplary embodiments, routing algorithm interacts with all necessary control plane components including optimization policy manager 408, policy manager 406, user tables, and user attribute tables.

Upon receiving a request, in various exemplary embodiments, the WSG 402 invokes routing table 410, which runs an algorithm to choose the web service based on the optimization policy. In various exemplary embodiments, routing table 410 accesses the data stored in the class of services table 418 to determine class of service information regarding the requested web service, then retrieves the corresponding optimization policy 416 for the requested web service. Then, in various exemplary embodiments, routing table 410 determines the appropriate web service based on the retrieved class of service information and optimization policy. Thus, in various exemplary embodiments, broker 114 applies the class of service information to the retrieved optimization policy to determine which location should receive the forwarded web service request.

Control plane 404 of exemplary system 400 includes a forwarding table 422, which, in various exemplary embodiments, receives the processed request from routing table 410. In various exemplary embodiments, forwarding table 422 processes the web service request by looking up the appropriate host for the selected web service location. Thus, in various exemplary embodiments, forwarding table 422 determines the web service URL and port number contained in forwarding table 422 and sends the request to the appropriate host location based on this information.

Exemplary system 400 includes two companies, first company 430 and second company 440. In various exemplary embodiments, first company 430 includes first company WSG 432, service A host 434, and service B host 436. Thus, in various exemplary embodiments, first company WSG 432 receives a forwarded request from WSG 402, processes the request, and forwards the request to the appropriate host for execution.

In various exemplary embodiments, second company 440 does not include a web services gateway and instead includes two hosts that communicate directly with WSG 402. Thus, in various exemplary embodiments, second company 440 includes web service A host 442, which supports a first web service A, and web service B host 444, which supports a second web service B.

It should be apparent that, while exemplary system 400 includes a separate host for each web service, a single host may support multiple web services. Thus, in various exemplary embodiments, web service A host 434, web service B host 436, web service A host 442, and/or web service B host 444 support multiple web services.

Accordingly, in various exemplary embodiments, exemplary system 400 dynamically manages forwarding of web service requests based upon an optimization policy. For example, first company 430 may offer a lower yearly service access cost and better quality of service for web service A than second company 440. In various exemplary embodiments, exemplary system 400 represents this cost and quality of service information in the optimization policies 416 and accesses these policies 416 when processing web service requests. In various exemplary embodiments, exemplary system 400 splits and re-directs traffic to either first company 430 or second company 440, thereby dynamically addressing the differing cost and quality of service for the requested web service.

FIG. 5 is a diagram illustrating an exemplary embodiment of a class of services table 418 used in connection with an exemplary system for application sensitive forwarding. In various exemplary embodiments, the class of services table 418 stores information regarding the provider (first column), associated services (second column), and information regarding the class of service for each provided service (third column).

Thus, in the exemplary embodiment of class of services table 418 illustrated in FIG. 5, Company 1 provides web service A at a minimum cost (first row of data) and web service B at a “Gold” level of service (fourth row of data). As further illustrated in exemplary class of services table 418, Company 2 provides web service A at an average cost (second row of data), while providing web service B at a “Silver” level of service (fifth row of data). Finally, as depicted, Company 3 provides web service A at a maximum cost, but does not provide web service B (third row of data).

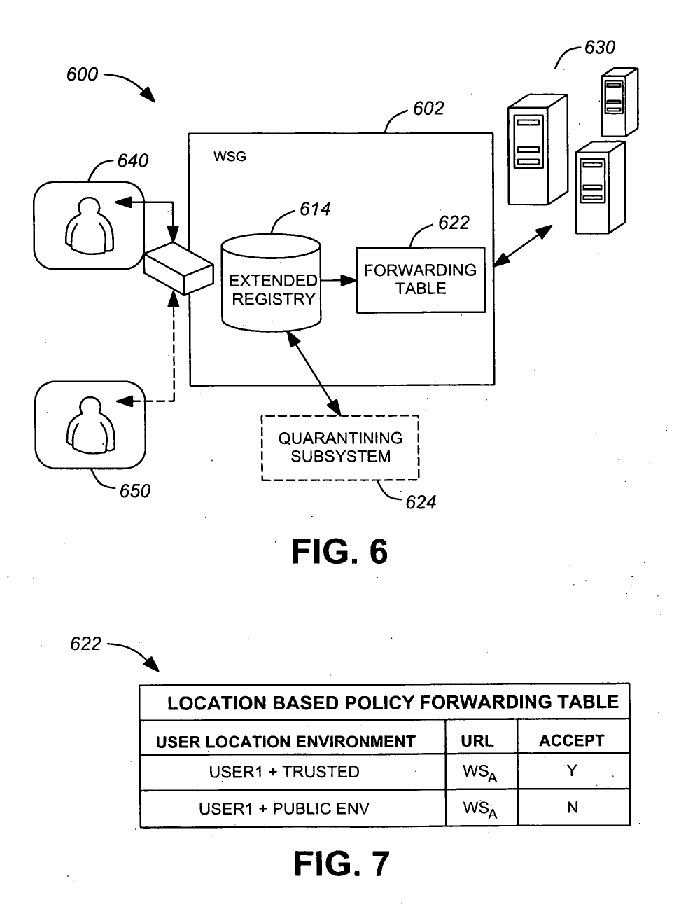

FIG. 6 is a schematic diagram of an exemplary embodiment of a system 600 for restricting access to web services using a location-based and security-based policy. Exemplary system 600 provides enterprises the ability to control access to internal web services by providing alternate services or grades of service based upon an application-level security policy. In various exemplary embodiments, the application-level security policy reflects criteria including user credentials, access restrictions, and the trust level at the current location of the user.

Exemplary system 600 includes a web services gateway (WSG) 602, which includes extended registry 614 and forwarding table 622. Exemplary system 600 further includes quarantining subsystem 624, web service A host 630, trusted environment 640, and non-trusted environment 650.

Extended registry 614 of exemplary system 600 stores location-based and security-based policies. Thus, in various exemplary embodiments, extended registry 614 stores a location-based policy that defines different trust environments and determines access privileges based on the user, environment, and web service in question. Moreover, in various exemplary embodiments, extended registry 614 stores a security-based policy that determines whether an incoming request needs to be sent to quarantine subsystem 624 for further inspection based on an inspection of the request and access patterns.

Exemplary system 600 defines trust environments using location-based policies. Thus, in various exemplary embodiments, system 600 includes a trusted environment 640 and a non-trusted environment 650. In various exemplary embodiments, trusted environment 640 encompasses computer systems within the corporate intranet, while non-trusted environment 650 includes connections via a Virtual Private Network (VPN) protocol and other third party access.

In various exemplary embodiments, when WSG 602 receives an incoming request, WSG 602 determines the service requested, the identity of the requesting user, and current security conditions. Based on the policies stored in extended registry 614, in various exemplary embodiments, WSG 602 determines whether to forward the request for execution by accessing forwarding table 622 using the identity and location of the user. When WSG 602 determines that the request should be accepted, WSG 602 forwards the request for execution at the appropriate host, such as service A host 630. When WSG 602 determines not to forward the request, WSG 602 routes the request to quarantining subsystem 624.

In various exemplary embodiments, upon receiving a forwarded request, quarantining subsystem 624 analyzes the request for attacks and evaluates the security risks associated with the request for a given user and application. After quarantining subsystem 624 analyzes the request, in various exemplary embodiments, the request is inserted back into the data path of WSG 602 for forwarding to the appropriate host. In various exemplary embodiments, the request is logged and dropped for offline analysis.

Accordingly, in various exemplary embodiments, exemplary system 600 dynamically controls access to internal web services based upon an application level-security policy. Thus, in various exemplary embodiments, exemplary system 600 enforces access restrictions by cross-referencing the user's access patterns with a location-based policy and a security-based policy.

FIG. 7 is a diagram illustrating an exemplary embodiment of a location-based policy forwarding table 622 used in connection with an exemplary system for restricting access to web services. In various exemplary embodiments, location-based policy forwarding table stores information regarding each user, his or her possible locations, the URL for the associated web service, and whether to accept a request from the specified user for that service.

Thus, in the exemplary embodiment of location-based policy forwarding table 622 illustrated in FIG. 7, when a user requesting service A is in trusted environment 640, WSG 602 accepts the request and forwards it to service A host 630. When the user requesting service A is in a non-trusted environment, WSG 602 does not accept the request and forwards the request to quarantining subsystem 624 for further analysis.

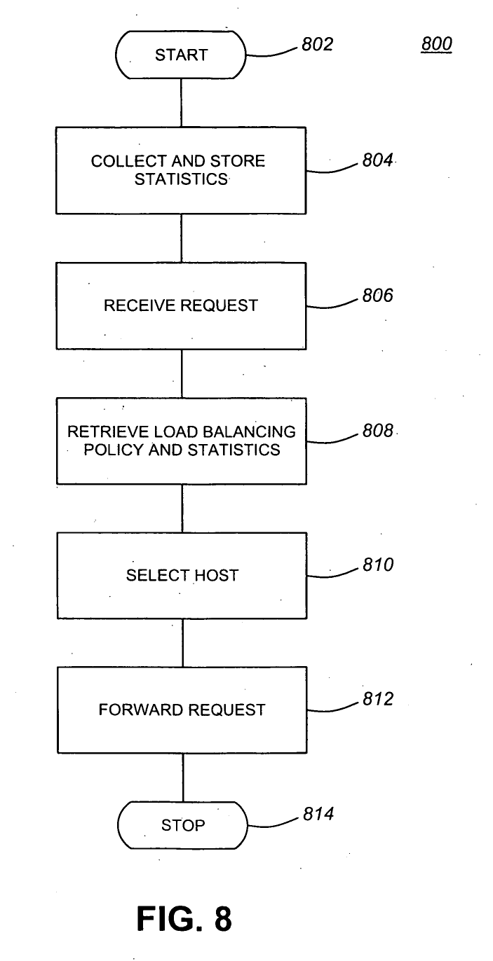

FIG. 8 is a flow chart of an exemplary embodiment of a method 800 for application sensitive forwarding based on an application layer load balancing model. Exemplary method 800 starts in step 802 and proceeds to step 804, where the method 800 collects and stores statistics regarding at least one web service. In various exemplary embodiments, stats collector 118 of WSG 102 gathers statistics regarding each web service and stores the statistics in metric table 112. In addition, in various exemplary embodiments, metric table 112 stores data regarding load balancing criteria including one or more of peak hour distribution of web service requests, geographic time frames, application request locations, and average service response time.

Exemplary method 800 then proceeds to step 806, where the method 800 receives an incoming web service request from a client. In various exemplary embodiments, WSG 102 receives the request, which is in either SOAP or XML format.

Exemplary method 800 then proceeds to step 808, where the method 800 retrieves at least one load balancing policy and statistics regarding the requested web service. Thus, in various exemplary embodiments, broker 114 accesses extended registry 108 to download load balancing policies 110 and metric table 112 in step 808.

After receiving the request and retrieving load balancing policies and statistics, exemplary method 800 then proceeds to step 810, where the method 800 selects a host based on the retrieved information. In various exemplary embodiments, WSG 102 invokes broker 114, which applies the current load information to the retrieved balancing policy to determine which location should receive the forwarded web service request.

Exemplary method 800 then proceeds to step 812, where the web service request is forwarded to the selected host. In various exemplary embodiments, broker 114 accesses forwarding table 122 to look up the appropriate host destination based upon the results of the processing performed at broker 114. Moreover, in various exemplary embodiments, forwarding table 122 determines the web service URL and port number, and then forwards the request to that destination for execution. After forwarding the request, exemplary method 800 proceeds to step 814, where the method 800 stops.

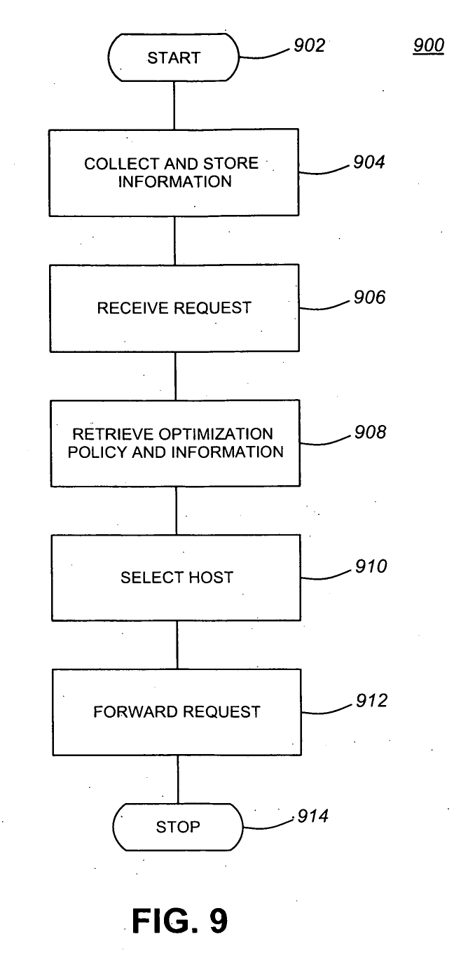

FIG. 9 is a flow chart of an exemplary embodiment of a method 900 for application sensitive forwarding based on optimization policies. Exemplary method 900 starts in step 902 and proceeds to step 904, where the method 900 collects and stores information regarding at least one web service. Thus, in various exemplary embodiments, the class of services table 418 stores information regarding optimization criteria, which include at least one of the cost of the service to the corporation and the service level of the web service (e.g. gold, silver, etc.).

Exemplary method 900 then proceeds to step 906, where the method 900 receives an incoming web service request from a client. In various exemplary embodiments, WSG 402 receives the request, which is in either SOAP or XML format.

Exemplary method 900 then proceeds to step 908, where the method 900 retrieves the stored information regarding the web service and at least one optimization policy. Thus, in various exemplary embodiments, routing table 410 accesses the data stored in the class of services table 418 to determine class of service information regarding the requested web service, then retrieves the corresponding optimization policy 416 for the requested web service in step 908.

After receiving the request and retrieving optimization policies and the stored web service information, exemplary method 900 then proceeds to step 910, where the method 900 selects a host based on the retrieved information. In various exemplary embodiments, routing table 410 determines the appropriate web service based on the retrieved class of service information and optimization policy. Thus, in various exemplary embodiments, routing table 410 applies the class of service information to the retrieved optimization policy to determine which location should receive the forwarded web service request.

Exemplary method 900 then proceeds to step 912, where the web service request is forwarded to the selected host. In various exemplary embodiments, routing table 410 accesses forwarding table 422 to look up the appropriate host destination based upon the results of the processing performed at routing table 410. Moreover, in various exemplary embodiments, forwarding table 422 determines the web service URL and port number, and then forwards the request to that destination for execution. After forwarding the request, exemplary method 900 proceeds to step 914, where the method 900 stops.

According to the forgoing, various exemplary embodiments dynamically enforce application-level policies on all transactional traffic. Thus, in various exemplary embodiments, the network enforces these policies, rather than relying on the web service applications at network end points for enforcement. Moreover, in various exemplary embodiments, application-level routing allows the enterprise to significantly reduce operational cost on its application servers, minimize usage costs on consumption of external web services, and provide application-level security based upon the credentials and location of an external user.

Although the various exemplary embodiments have been described in detail with particular reference to certain exemplary aspects thereof, it should be understood that the invention is capable of other different embodiments, and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only, and do not in any way limit the invention, which is defined only by the claims.

What is claimed is:

1. A system for application sensitive forwarding of a request for a web service, the system comprising:
a broker that manages the forwarding of the request;
a metric table that stores statistics for the web service collected regarding at least one load balancing criterion; and
a database storing the metric table and least one load balancing policy, wherein
the broker retrieves, from the database, the at least one load balancing policy and at least one entry from the metric table, and
the broker forwards the request to a host selected by applying the at least one load balancing policy to the at least one entry from the metric table.

2. The system for application sensitive forwarding of a request for a web service according to claim 1, further comprising a forwarding table that directs a processed request to the selected host.

3. The system for application sensitive forwarding of a request for a web service according to claim 2, wherein the forwarding table stores information regarding at least one of a user type, a web service URL, and a web service port.

4. The system for application sensitive forwarding of a request for a web service according to claim 2, further comprising a routing module that sends the processed request from the broker to the forwarding table.

5. The system for application sensitive forwarding of a request for a web service according to claim 1, further comprising a statistics collector that collects data regarding the at least one load balancing criterion and stores the data in the metric table.

6. The system for application sensitive forwarding of a request for a web service according to claim 1, wherein the at least one load balancing criterion comprises at least one of peak hour distribution of web service requests, geographic time frame, application request location, and average service response time.

7. The system for application sensitive forwarding of a request for a web service according to claim 1, wherein the request is in a format selected from the list consisting of XML and SOAP.

8. A system for application sensitive forwarding of a request for a web service, the system comprising:
an optimization policy manager that manages forwarding of the request;
a class of services table that stores information regarding at least one optimization criterion; and
a database storing the class of services table and at least one optimization policy, wherein
the broker retrieves, from the database, the at least one optimization policy and at least one entry from the class of services table, and
the broker forwards the request to a host selected by applying the at least one optimization policy to the at least one entry from the class of services table.

9. The system for application sensitive forwarding of a request for a web service according to claim 8, further comprising a forwarding table that directs a processed request to the selected host.

10. The system for application sensitive forwarding of a request for a web service according to claim 9, wherein the forwarding table stores information regarding at least one of a user type, a web service URL, and a web service port.

11. The system for application sensitive forwarding of a request for a web service according to claim 8, wherein the at least one optimization criterion comprises at least one of a cost of the web service and a service level of the web service.

12. The system for application sensitive forwarding of a request for a web service according to claim 8, wherein the request is in a format selected from the list consisting of XML and SOAP.

13. A system for processing a request to a web service to restrict access, the system comprising:
a database storing at least one security-based policy and at least one location-based policy defining trust environments, the trust environments based on the location of a client;
a request processor that receives the request from the client and determines a current environment of the client based on the at least one location-based policy; and
a quarantining subsystem that receives the request from the request processor when the current environment of the client is a non-trusted environment, applies the security-based policy to the request, and drops the request when the request violates the security-based policy.

14. The system for processing a request to a web service to restrict access according to claim 13, wherein the request processor is one of a web services gateway, a web services intranet platform, and a web services manager.

15. The system for processing a request to a web service to restrict access according to claim 13, further comprising a forwarding table that specifies whether to accept the request from the client based on the current environment of the client and the requested web service.

16. The system for processing a request to a web service to restrict access according to claim 15, wherein the forwarding table specifies a URL of the web service.

17. The system for processing a request to a web service to restrict access according to claim 13, wherein the quarantining subsystem inserts the request back into a data path of the request processor when the request does not violate the security-based policy.

18. The system for processing a request to a web service to restrict access according to claim 13, wherein the request is in a format selected from the list consisting of XML and SOAP.

19. A method for application sensitive forwarding of a request for a web service, the method comprising:
storing statistics for the web service regarding at least one load balancing criterion, the at least one load balancing criterion specifying at least one metric regarding the web service;
receiving the request from a client;
retrieving at least one load balancing policy and the statistics, the at least one load balancing policy being different than the at least one load balancing criterion;
selecting a host by applying the at least one load balancing policy to the statistics; and
forwarding the request to the selected host.

20. The method for application sensitive forwarding of a request for a web service according to claim 19, further comprising determining a web service URL and a web service port for the selected host.

21. The method for application sensitive forwarding of a request for a web service according to claim 19, wherein the at least one load balancing criterion comprises at least one of peak hour distribution of web service requests, geographic time frame, application request location, and average service response time.

22. The method for application sensitive forwarding of a request for a web service according to claim 19, wherein the request is in a format selected from the list consisting of XML and SOAP.

23. A method for application sensitive forwarding of a request for a web service, the method comprising:
storing information for the web service regarding at least one optimization criterion, the at least one optimization criterion specifying at least one metric regarding the web service;
receiving the request from a client;
retrieving at least one optimization policy and the information, the at least one optimization policy being different than the at least one optimization criterion;
selecting a host by applying the at least one load optimization policy to the information; and
forwarding the request to the selected host.

24. The method for application sensitive forwarding of a request for a web service according to claim 23, wherein the at least one optimization criterion comprises at least one of a cost of the web service and a service level of the web service.

25. The method for application sensitive forwarding of a request for a web service according to claim 23, wherein the request is in a format selected from the list consisting of XML and SOAP.
